(19) United States
(12) Patent Application Publication
(10) Pub. No.: US 2019/0055992 A1
(43) Pub. Date: Feb. 21, 2019

(54) STEEL PLATE FOR A MULTI-PLATE CLUTCH

(71) Applicant: Schaeffler Technologies AG & Co. KG, Herzogenaurach (DE)

(72) Inventor: Markus HESSE, Pfinztal (DE)

(73) Assignee: Schaeffler Technologies AG & Co. KG, Herzogenaurach (DE)

(21) Appl. No.: 15/770,531

(22) PCT Filed: Nov. 25, 2016
(86) PCT No.: PCT/DE2016/200547

§ 371 Date: Apr. 24, 2018

(30) Foreign Application Priority Data
Dec. 4, 2015 (DE) 10 2015 224 263.3

(51) Int. Cl. F16D 13/64; F16D 13/68

(52) U.S. Cl. CPC F16D 13/648; F16D 13/683; F16D 2250/0069; F16D 2250/0023; F16D 2200/0021

(57) ABSTRACT

A steel plate for a multi-plate clutch includes a plurality of circular-arc-like segments, each one of the circular-arc-like segments securely connected to an adjacent one of the circular-arc-like segments. Each one of the circular-arc-like segments has a base member formed as an annular disk and a tooth arrangement for providing a rotationally secure connection with respect to a plate carrier. Each one of the circular-arc-like segments may be formed as a stamped portion. The plurality of circular-arc-like segments may consist of at least three circular-arc-like segments and at most nine circular-arc-like segments. The tooth arrangement may be an outer tooth arrangement.

### CROSS-REFERENCE TO RELATED APPLICATIONS

This application is the United States National Phase of PCT Appln. No. PCT/DE2016/200547 filed Nov. 25, 2016, which claims priority to German Application No. DE102015224263.3 filed Dec. 4, 2015, the entire disclosures of which are incorporated by reference herein.

### TECHNICAL FIELD

The disclosure relates to a steel plate for a multi-plate clutch, having a base member which is substantially in the form of an annular disk, and having a tooth arrangement which is used to constitute a rotationally secure connection with respect to a plate carrier. The disclosure also relates to a method for producing such a steel plate.

### BACKGROUND

DE 10 2013 212 185 A1 discloses a segmented carrier plate for at least one covering element, such as a plate, having at least two segments which are connected to each other in a materially engaging manner. DE 10 2007 053 758 A1 discloses a segmented carrier plate for a plate which is composed of at least two segments in a puzzle-like manner so as to form a boundary line between the segments, wherein one segment has a projection which is inserted in a recess in the other segment so as to form a boundary line portion between the projection and the recess, and the projection and the recess are formed in such a manner that the adjacent segments engage behind each other with respect to the peripheral direction in at least a first and a second part-portion of the boundary line portion, wherein the projection of the first part-portion in a peripheral direction onto a radial plane at least partially intersects with the projection of the second part-portion in a peripheral direction onto the radial plane.

### BRIEF SUMMARY

Example aspects broadly comprise a steel plate for a multi-plate clutch, having a base member which is substantially in the form of an annular disk, and having a tooth arrangement which is used to constitute a rotationally secure connection with respect to a plate carrier, which steel plate is inexpensive to produce.

In an example aspect, a steel plate for a multi-plate clutch includes a base member which is substantially in the form of an annular disk, and a tooth arrangement which is used to constitute a rotationally secure connection with respect to a plate carrier. The steel plate is subdivided into a plurality of substantially circular-arc-like segments which are securely connected to each other. Conventional steel plates are produced, for example, by stamping, and are formed from one piece. As a result of the integral construction of the steel plates, a relatively great deal of waste is produced during the stamping. The waste which is produced during stamping can be substantially reduced by subdividing the steel plate into individual, substantially circular-arc-like segments.

An example embodiment of the steel plate is characterized in that the segments are formed as stamped portions. The construction of the segments as stamped portions affords the advantage that the steel plates can be produced in a simple and cost-effective manner. The stamped portions may have a thickness of approximately two millimeters.

Another example embodiment of the steel plate is characterized in that the steel plate comprises from three to nine segments. During tests carried out in the context of the present disclosure, it has been found that a number of from three to nine segments, in particular from four to six segments, is particularly highly suitable for use in a multi-plate clutch.

Another example embodiment of the steel plate is characterized in that the steel plate is provided with an outer tooth arrangement. The outer tooth arrangement is used to constitute a rotationally secure connection between the steel plate and a plate carrier of the multi-plate clutch. The steel plate is suspended with the outer tooth arrangement in a complementary inner tooth arrangement of an outer plate carrier of the multi-plate clutch.

Another example embodiment of the steel plate is characterized in that a connection between two segments comprises on a first segment a projection which engages in a recess of a second segment. The projection constitutes a type of stud which engages in a complementary recess. It is thereby possible to readily position the segments relative to each other.

Another example embodiment of the steel plate is characterized in that the segments are connected to each other in a positive-locking manner. The positive-locking connection may comprises at least one undercut. The connection between the segments is thereby safely prevented from becoming inadvertently released.

Another example embodiment of the steel plate is characterized in that the connection is secured by a fastener (e.g., a bolt) which extends through the projection of the first segment and through the second segment. The bolt may extend in a substantially radial direction through the projection of the first segment and through the second segment.

Another example embodiment of the steel plate is characterized in that the bolt is securely connected at the ends thereof to the second segment. The bolt can be connected securely to the second segment at the ends thereof in a materially engaging manner, for example, by welding. Alternatively or additionally, the bolt can be connected securely to the second segment at the ends thereof by over-stamping or caulking.

Another example embodiment of the steel plate is characterized in that the segments are connected to each other in a materially engaging manner, in particular by an adhesive connection. The segments may be provided at the ends thereof facing each other with oblique connection faces in order to increase the effective adhesive connection face.

In a method for producing an above-described steel plate, the substantially circular-arc-like segments may be connected to each other in a positive-locking and/or materially engaging manner. The positive-locking and/or materially engaging connection of the segments does not have to withstand any extreme loads because, when a torque is transmitted, a large portion of the forces is transmitted via the tooth arrangement, in particular the outer tooth arrangement, of the steel plate.

The disclosure further relates to a wet-running multi-plate clutch having at least one above-described steel plate.

### BRIEF DESCRIPTION OF THE DRAWINGS

Additional advantages, features and details of the disclosure will be appreciated from the following description, in which different embodiments are described in detail with reference to the drawings, in which:

FIG. 1 is a simplified side view of a steel plate which comprises two segments which are connected to each other in a positive-locking manner;

FIG. 2 shows the two segments of the steel plate from FIG. 1 before the connection;

FIG. 3 is a side view of a steel plate according to an additional embodiment having two segments which are also connected to each other in a positive-locking manner;

FIG. 4 is a plan view of the two segments from FIG. 3 before the production of the positive-locking connection;

FIG. 5 is a side view of the two segments from FIGS. 3 and 4 before the connection and

FIG. 6 shows a steel plate having two segments which are connected to each other in a materially engaging manner.

### DETAILED DESCRIPTION

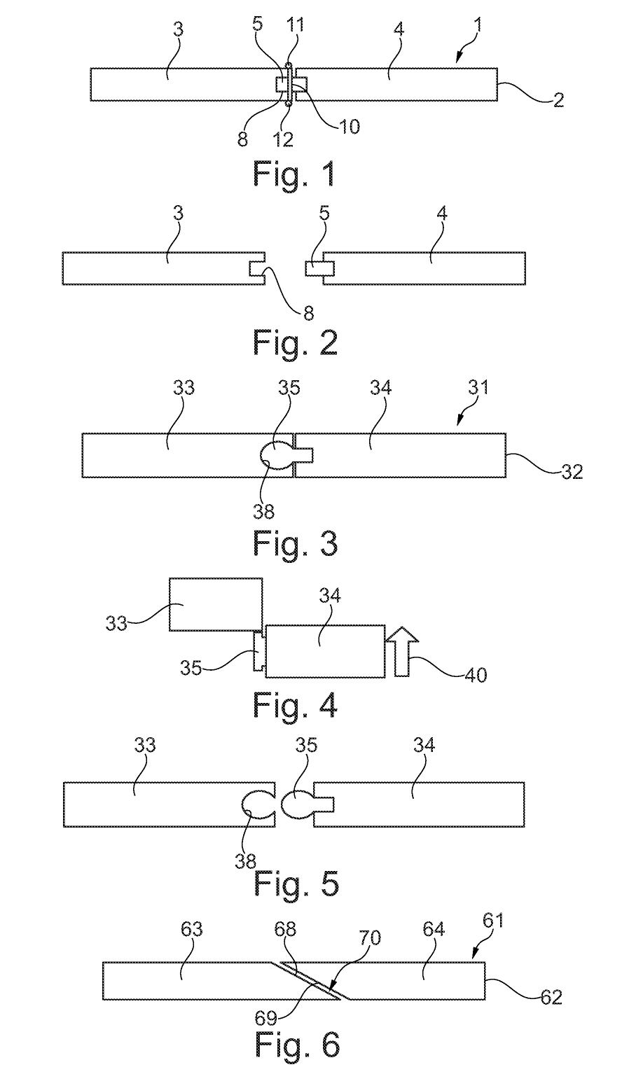

FIGS. 1 to 6 illustrate three embodiments of steel plates 1; 31; 61 as various views and in various states. The steel plates 1; 31; 61 each comprise an annular-disk-like base member 2; 32; 62. There is formed at the radially outer side on the annular-disk-like base member 2; 32; 62 an outer tooth arrangement (not illustrated) which is used to produce a rotationally secure connection with respect to an outer plate carrier of a wet-running multi-plate clutch (also not illustrated).

The steel plates 1; 31; 61 are each composed of two segments 3, 4; 33, 34; 63, 64. In the illustrated embodiments, only two segments 3, 4; 33, 34; 63, 64 are illustrated for the sake of simplicity. In the real application, however, the steel plates 1; 31; 61 may comprise more than two segments, in particular from four to six segments.

The segments 3, 4; 33, 34; 63, 64 are constructed as stamped portions. The use of segments in order to constitute the steel plates 1; 31; 61 affords, in comparison with completely stamped-out, that is to say, integral, steel plates, the advantage that substantially less waste is produced during the stamping.

The embodiments of the steel plates 1; 31; 61 which are illustrated in FIGS. 1 to 6 set out different possible methods as to how the segments 3, 4; 33, 34; 63, 64 can be connected to each other in a simple and stable manner.

In the steel plate 1 which is illustrated in FIGS. 1 and 2, a first segment 4 has a projection 5. The projection 5 is advantageously connected to the segment 4 in an integral manner. A second segment 3 comprises a recess 8 which is constructed so as to complement the projection 5.

FIG. 2 illustrates the segments 3 and 4 before the production of a positive-locking connection. In FIG. 1, the projection 5 of the first segment 4 engages in a positive-locking manner in the recess 8 of the second segment 3. The positive-locking connection in FIG. 1 is secured by a bolt 10.

The bolt 10 extends in the region of the recess 8 through the second segment 3 and through the projection 5 of the first segment 4 arranged in the recess 8. The bolt ends 11, 12 of the bolt 10 are connected in a materially engaging manner to the second segment 3 of the steel plate 1 by welding spots.

In the steel plate 31 illustrated in FIGS. 3 to 5, a first segment 34 has a projection 35. The projection 35 is, as can be seen in the side views of FIGS. 3 and 5, substantially in the form of an oval or an ellipse.

FIG. 4 shows the projection 35 from above, with respect to FIG. 3, but not illustrated to scale, that is to say, smaller than in FIGS. 3 and 5. The projection 35 of the first segment 34 engages in a positive-locking manner in a recess 38 which is stamped in a second segment 33.

FIG. 3 illustrates the positive-locking connection in a closed state. FIG. 4 indicates with an arrow 40 how the two segments 33, 34 are moved relative to each other in order to produce the positive-locking connection. FIG. 5 illustrates the two segments 33, 34 before the production of the positive-locking connection.

The segments 63, 64 of the steel plate 61 illustrated in FIG. 6 have oblique faces 68, 69 at the ends thereof facing each other. The segments 63, 64 are connected to each other in a materially engaging manner by an adhesive connection 70 at the oblique faces 68, 69. The effective adhesive face is readily increased by the oblique faces 68, 69. The adhesive connection is may be produced with an adhesive which withstands temperatures of more than three hundred degrees Celsius.

### LIST OF REFERENCE NUMERALS

1 Steel plate
2 Base member
3 Segment
4 Segment
5 Projection
8 Recess
10 Bolt
11 Bolt end
12 Bolt end
31 Steel plate
32 Base member
33 Segment
34 Segment
35 Projection
38 Recess
40 Arrow
61 Steel plate
62 Base member
63 Segment
64 Segment
68 Oblique face
70 Adhesive device

1.-10. (canceled)

11. A steel plate for a multi-plate clutch comprising:
a plurality of circular-arc-like segments, each one of the circular-arc-like segments securely connected to an adjacent one of the circular-arc-like segments, each one of the circular-arc-like segments comprising:
a base member formed as an annular disk; and,
a tooth arrangement for providing a rotationally secure connection with respect to a plate carrier.

12. The steel plate of claim 11, wherein each one of the circular-arc-like segments are formed as a stamped portion.

13. The steel plate of claim 11, wherein the plurality of circular-arc-like segments consists of at least three circular-arc-like segments and at most nine circular-arc-like segments.

14. The steel plate of claim 11 wherein the tooth arrangement is an outer tooth arrangement.

15. The steel plate of claim 11, wherein:
each one of the circular-arc-like segments comprises a projection and a recess; and,
each projection in the one of the circular-arc-like segments is engaged with the recess in the adjacent one of the circular-arc-like segments to securely connect the one of the circular-arc-like segments to the adjacent one of the circular-arc-like segments.

16. The steel plate of claim 15, wherein the one of the circular-arc-like segments and the adjacent one of the circular-arc-like segments are connected to each other in a positive-locking manner.

17. The steel plate of claim 15 further comprising a fastener which extends through the projection of the one of the circular-arc-like segments and through the adjacent one of the circular-arc-like segments to secure the connection.

18. The steel plate of claim 17, wherein the adjacent one of the circular-arc-like segments comprises an end including the recess and the fastener is securely connected at the end.

19. The steel plate of claim 11 wherein the one of the circular-arc-like segments is connected to the adjacent one of the circular-arc-like segments in a materially engaging manner.

20. The steel plate of claim 19 wherein the materially engaging manner is an adhesive connection.

21. A method for producing the steel plate of claim 11 comprising connecting the one of the circular-arc-like segments with the adjacent one of the circular-arc-like segments in a positive-locking manner.

22. A method for producing the steel plate of claim 11 comprising connecting the one of the circular-arc-like segments with the adjacent one of the circular-arc-like segments in a materially engaging manner.
